(19) United States
(12) Patent Application Publication
(10) Pub. No.: US 2006/0143520 A1
(43) Pub. Date: Jun. 29, 2006

(54) Network connectable household electric appliance, household appliance inspecting system and household electric appliance inspecting service

(76) Inventors: Hiroaki Matsushima, Ryugasaki (JP); Sadao Hirose, Oohira (JP); Hidenori Yokoyama, Nikko (JP); Kazuhiro Fukuyo, Ube (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/360,697

(22) Filed: Feb. 24, 2006

Related U.S. Application Data
(63) Continuation of application No. 10/309,023, filed on Dec. 4, 2002.

(30) Foreign Application Priority Data
Dec. 7, 2001 (JP) 2001-373527

(51) Int. Cl. G06F 11/00

(52) U.S. Cl. 714/25

(57) ABSTRACT

Network connectable household electric appliances in general home, such as refrigerators, washing machines, microwave ovens, air conditioners and lighting fixtures and a workstation of a service center are connected to permit communication therebetween. The workstation transmits a password and a running information request signal to a household electric appliance at intervals of a constant period, reads the running information stored in the household electric appliance and compares the running information with a reference value stored in appliance data so as to perform periodic inspection of the appliance. Not only in case a fault or abnormality occurs but also in case no fault or abnormality is detected, the result of inspection is informed to the user.

### CROSS REFERENCE TO RELATED APPLICATIONS

This application is a continuation application of U.S. application Ser. No. 10/309,023, filed Dec. 4, 2002, the contents of which are incorporated herein by reference.

### BACKGROUND OF THE INVENTION

The present invention relates to maintenance and inspection of household electric appliances for use in general homes provided with the communication function.

Conventionally, many household electric appliances, such as refrigerators, air conditioners, washing machines, vacuum cleaners, lighting fixtures, microwave ovens, televisions and video players, have been used in homes. Generally, when it comes to maintaining and inspecting these household electric appliances, a user informs a shop or a production maker of a fault in the event that the fault occurs in a household electric appliance and a maintenance service engineer is dispatched from the shop or production maker to a user's house so as to repair the fault, or depending on the kind of the product, the user brings the faulty appliance to the shop to request repair. Such a procedure as above is, however, disadvantageous in that much time is consumed following the occurrence of the fault before the service engineer starts repair of the appliance. In the case of absence of parts in hand, there arises another problem that even if the service engineer specifies a faulty spot, the number of days will further pass before parts come to hand.

To get rid of such inconvenience as above, JP-A-2000-121238 (publication 1) describes that by providing a household electric appliance with a diagnostic function and causing communication means to inform a service center of a fault in the event of the occurrence of the fault in the household electric appliance, preparation for repair including preparation for replaceable parts can be made in advance. This permits a quicker response to the fault.

Typically, the contact from the user is however made at the time that the household electric appliance is rendered inoperative or the function desired for use becomes out of order and therefore, the household electric appliance cannot be used or part of functions cannot be used before repair is completed. Further, even with a household electric appliance rendered to be defective, only information purporting, for example, “the refrigerator does not operate”, “the air conditioner does not cool” or “the television does not display” can be obtained and details of the contents of a fault cannot be known, so that a maintenance service engineer needs to inspect the household electric appliance at a user's house to grasp the concrete contents of the fault and thereafter make preparation for faulty parts, thus raising a problem that much time is consumed for repair.

The household electric appliance provided with the diagnostic function can specify a faulty spot but the diagnostic function differs with individual appliances and disadvantageously, a detailed analysis can be performed only at increased expense.

As a technique of solving the problems faced in publication 1 to a possible extent, a technique disclosed in JP-A-4-241563 (publication 2) is available, according to which a fault occurring in an appliance is informed by a user of the appliance through the medium of a center telephone and when a center receiving the telephone call instructs the user to connect the telephone line to the appliance, running data is transmitted from the appliance to the center so as to permit the fault to be diagnosed and a service engineer having the result of diagnosis in mind goes to a user's house. In the technique described in the reference 2, however, the user needs to take some time for giving information to the center and for switching the telephone line. Techniques described in publications 3 and 4 as below are to solve the aforementioned problems.

JP-A-2000-245595 (publication 3) describes that a showcase controller for collecting running information of a plurality of showcases is provided on the user's side and when detecting a fault, the showcase controller transmits running information collected till then, together with an abnormal alarm, to a center and the center side catches causes of the fault and attends to maintenance and inspection.

JP-A-2000-196769 (publication 4) also describes a similar technique. More particularly, a unit information management device for managing running information of a plurality of household electric appliances is installed in a house and the unit information management device causes a fault diagnosis device provided in the household electric appliance to detect a fault occurring in a household electric appliance and collects periodically the running information of the household electric appliance, whereby in the case of the occurrence of a fault, the management device transmits information on the fault and diagnostic information of the electric product to a center but in the case of no fault, transmits the diagnostic information periodically to the center. Then, in the event of the occurrence of a fault, causes of the fault are analyzed on the center side and the result of analysis is offered to a service engineer to ensure a quick response.

In the techniques described in the aforementioned publications 3 and 4, work to diagnose disordered spots of the appliance and specify a faulty spot is carried out in the center but a flag to the effect that the appliance is defective is set up by a unit installed on the user side, with the result that disadvantageously, a fault diagnostic unit needs to be provided on the user side. Accordingly, if an appliance undergoing a fault diagnosis (such as a household electric appliance) is exchanged with a newly bought one, the software in the fault diagnostic unit installed in the house must disadvantageously be changed. Publication 4 having a fault diagnosis circuit provided in a household electric appliance faces problems similar to those encountered in reference 1.

JP-A-4-344758 (publication 5) describes that a target appliance is a drainage pump for use in general homes and a center monitors periodically the appliance in general home so that repair may be done by a service engineer in the event of the occurrence of an abnormality. More particularly, the center attends an appliance in general home by reading various kinds of running data stored in the appliance through a telephone line, whereby in the event of the occurrence of an abnormality, information to this effect is given to the general home and the service engineer goes to the house so as to perform repair.

### BRIEF SUMMARY OF THE INVENTION

Generally, the fault diagnosis and maintenance service described in the aforementioned publications 3 to 5 are carried out by making a contract for chargeable maintenance between a user of a service target appliance and the center or maker.

But, the above prior arts face a problem that the appliance user cannot confirm fulfillment conditions of the contract and cannot help feeling uneasy.

Further, even with the maintenance as above executed, the household electric appliance sometimes becomes out of order.

An object of this invention is to provide a household electric appliance inspecting system capable of inspecting a household electric appliance inexpensively without providing special diagnosis means in the household electric appliance and of preventing a user or possessor of the appliance from feeling uneasy.

Another object of the invention is to provide a household electric appliance capable of being serviced even in an event of the occurrence of an unexpected fault of the household electric appliance.

Still another object of the invention is to provide a service capable of inspecting a household electric appliance inexpensively without providing special diagnosis means in the household electric appliance and preventing a user or possessor of the appliance from feeling uneasy.

The above objects can be accomplished by providing a function of storing running information of a household electric appliance connected through a network, a function of deciding from the stored running information whether the household electric appliance operates normally, and a function of converting, when no abnormality or fault is detected, a message to this effect into electronic mail and transmitting the electronic mail to a display unit provided in the household electric appliance or a terminal unit possessed by a user of the household electric appliance.

The above objects can be accomplished by providing a function of storing running information of a household electric appliance connected through a network, a function of deciding from the stored running information whether the household electric appliance operates normally and a function of preparing, when no abnormally or fault is detected, a postal card describing a message to this effect.

The above objects can be accomplished by a household electric appliance inspecting system having a unit for deciding, on the basis of running information from a household electric appliance connected through a network, the presence or absence of a fault or abnormality of the household electric appliance, wherein the system comprises a function of converting into electronic mail an inquiry made to a user of the household electric appliance and inquiring whether the service is to be continued, before a constant period following purchase of the household electric appliance expires and transmitting the electronic mail to a display unit provided in the household electric appliance or a terminal unit possessed by the user of the household electric appliance.

The above objects can be accomplished by a household electric appliance inspecting system having a unit for deciding, on the basis of running information of a household electric appliance connected through a network, the presence or absence of a fault or abnormality of the household electric appliance, wherein the system comprised a function of preparing a postal card describing an inquiry made to a user of the household electric appliance and inquiring whether the service is to be continued, before a constant period following purchase of the household electric appliance expires.

The above objects can be accomplished by a household electric appliance having a transmitting and receiving unit connected to a network to make communication with the outside, wherein the appliance comprises a power source unit provided for the household electric appliance and a power source unit provided for the transmitting and receiving unit.

The above objects can be accomplished by a household electric appliance connected through a network to a service center for diagnosing a fault or abnormality of the household electric appliance on the basis of transmitted running information, wherein the appliance comprises a notification switch for informing the center of a fault and a function of transmitting running information of its own when the notification switch is turned on.

The above objects can be accomplished by a household electric appliance inspecting service which uses a unit for deciding, on the basis of running information from a household electric appliance connected through a network, the presence or absence of a fault or abnormality of the household electric appliance and dispatches a service engineer in the case the occurrence of a fault or abnormality, wherein a service based on the decision unit is given without charge during a constant period following purchase of the household electric appliance and after the constant period, a service based on the decision unit is given with charge when a request is made from a user of the household electric appliance.

The above objects can be accomplished by a household electric appliance inspecting service which uses a unit for deciding, on the basis of running information from a household electric appliance connected through a network, the presence or absence of a fault or abnormality of the household electric appliance and dispatches a service engineer in the case of the occurrence of a fault or abnormality, wherein a service based on the decision unit is given without charge during a constant period following purchase of the household electric appliance, and before expiration of the constant period, an inquiry is made to a user of the household electric appliance to inquire whether the user wants the service to be continued and after the constant period, a service based on the decision unit is given with charge when a request is made by the user of the household electric appliance.

Other objects, features and advantages of the invention will become apparent from the following description of the embodiments of the invention taken in conjunction with the accompanying drawings.

### BRIEF DESCRIPTION OF THE SEVERAL VIEWS OF THE DRAWING

FIG. 1 is a diagram showing the constitution of a system according to an embodiment of the invention.

FIG. 2 is a connection diagram of a refrigerator representing a network connectable household electric appliance.

FIG. 3 is a diagram showing the screen of liquid crystal display when running setting is selected.

FIG. 4 is a diagram showing the screen of liquid crystal display when communication environment is selected.

FIG. 5 is a diagram showing the screen of liquid crystal display when setting of “others” is selected.

FIG. 6 depicts customer data.

FIG. 7 is a flowchart of inspection.

FIG. 8 is a representation of notification information during normal operation.

FIG. 9 is a representation of notification information during abnormal operation.

FIG. 10 is a connection diagram showing another embodiment of a power source system of the invention.

FIG. 11 is a diagram showing the constitution of a system according to another embodiment of the invention.

### DETAILED DESCRIPTION OF THE INVENTION

Embodiments of the invention will now be described with reference to the accompanying drawings.

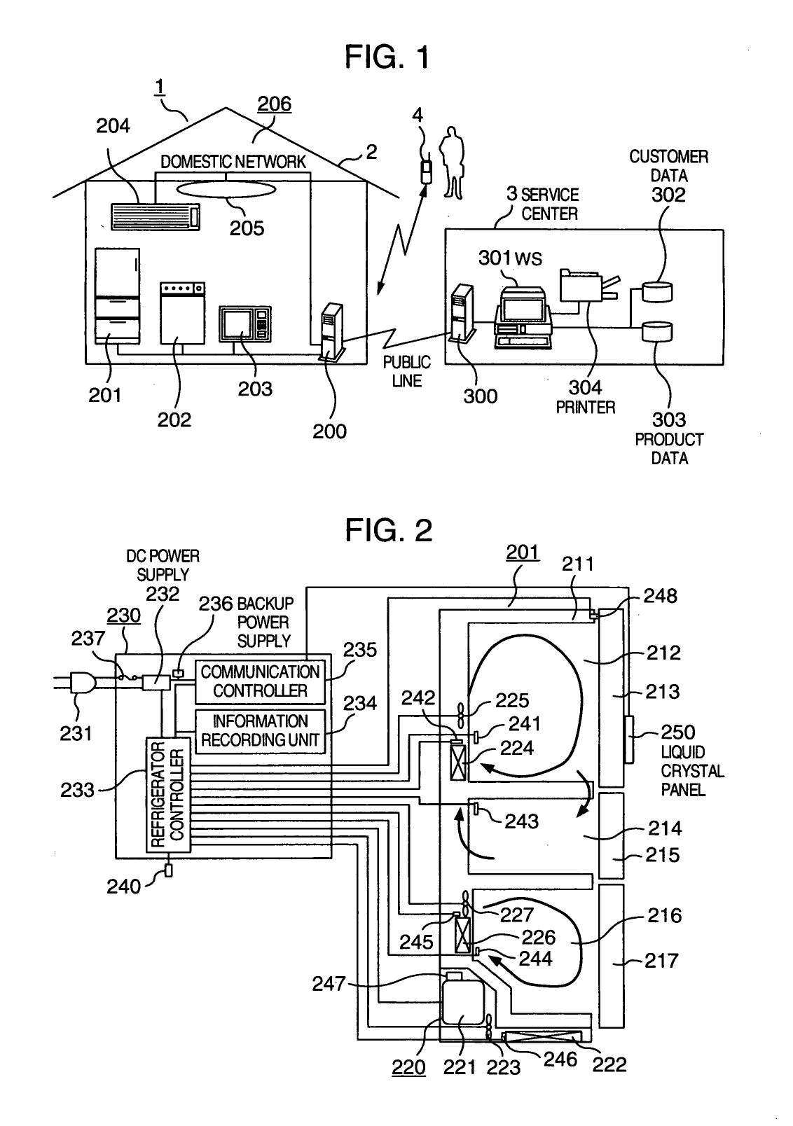

FIG. 1 is a diagram showing the constitution of a system according to an embodiment of the invention. In the system generally designated by reference numeral 1 and in which network connectable household electric appliances are connected, a domestic server 200 is connected to the network connectable household electric appliances 206 such as refrigerator 201, washing machine 202, microwave oven 203, air conditioner 204 and lighting fixture 205 through a domestic network in a general home 2, and the domestic server 200 is connected to a server 300 inside a service center 3 and also to a cell phone 4 serving as a portable terminal of a user through the medium of a public line such as the Internet.

A description will be given with reference to FIG. 2 by taking one of the network connectable household electric appliances, that is, the refrigerator 201 for instance. The refrigerator 201 is partitioned into a refrigerate compartment 212, a vegetable compartment 214 and a freezer compartment 216 by means of adiabatic boxes 211 and foodstuffs can be brought into or taken out of these chambers by using refrigerate compartment door 213, vegetable compartment door 215 and freezer compartment door 217, respectively. To cool the refrigerate compartment 212, vegetable compartment 214 and freezer compartment 216, a freezing cycle 220 is provided which includes a compressor 221, a condenser 222, a pressure reduction unit (not shown), a refrigerate compartment cooler 224 and a freezer compartment cooler 226. Chilled air is supplied to the refrigerate compartment 212 and vegetable compartment 214 by means of a cooling fan 225 for refrigerate compartment and chilled air is supplied to the freezer compartment 216 by means of a cooling fan 227 for freezer compartment. Operation of the refrigerator 201 is controlled with a controller 230 including a refrigerator controller 233 for digitally controlling the function of the refrigerator, a communication controller 235 having a terminal connected with a wiring line for network and an information recording unit 234 for recording, in advance, product information such as type, production number and the like and running information and is fed with electric power from a domestic power source through plug socket 231, fuse 237 and DC power supply 232. The communication controller 235 is provided with a backup power supply 236 serving as a power supply of different system to permit communication even during power failure. On the basis of detection values of individual detectors such as air temperature detector 240, refrigerate compartment temperature detector 241, refrigerate compartment cooler temperature detector 242, vegetable compartment temperature detector 243, freezer compartment temperature detector 244, freezer compartment cooler temperature detector 245, condenser temperature detector 246, compressor temperature detector 247 and door open/close detector 248, the refrigerator controller 233 controls the compressor 221 of freezing cycle 220, a fan 223 for condenser, the refrigerator fan 225 and the freezer compartment fan 227. These detection values and revolution numbers of the compressor 221 of freezing cycle, condenser fan 223, refrigerate compartment fan 225 and freezer compartment fan 227 are stored in the information recording unit 234.

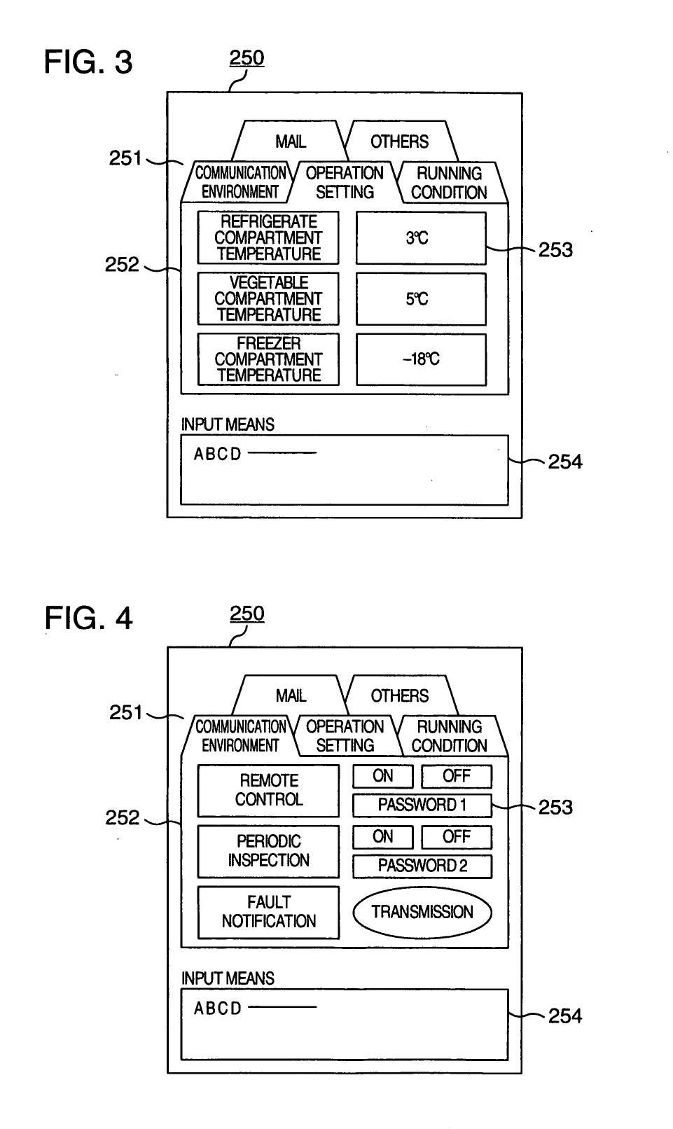

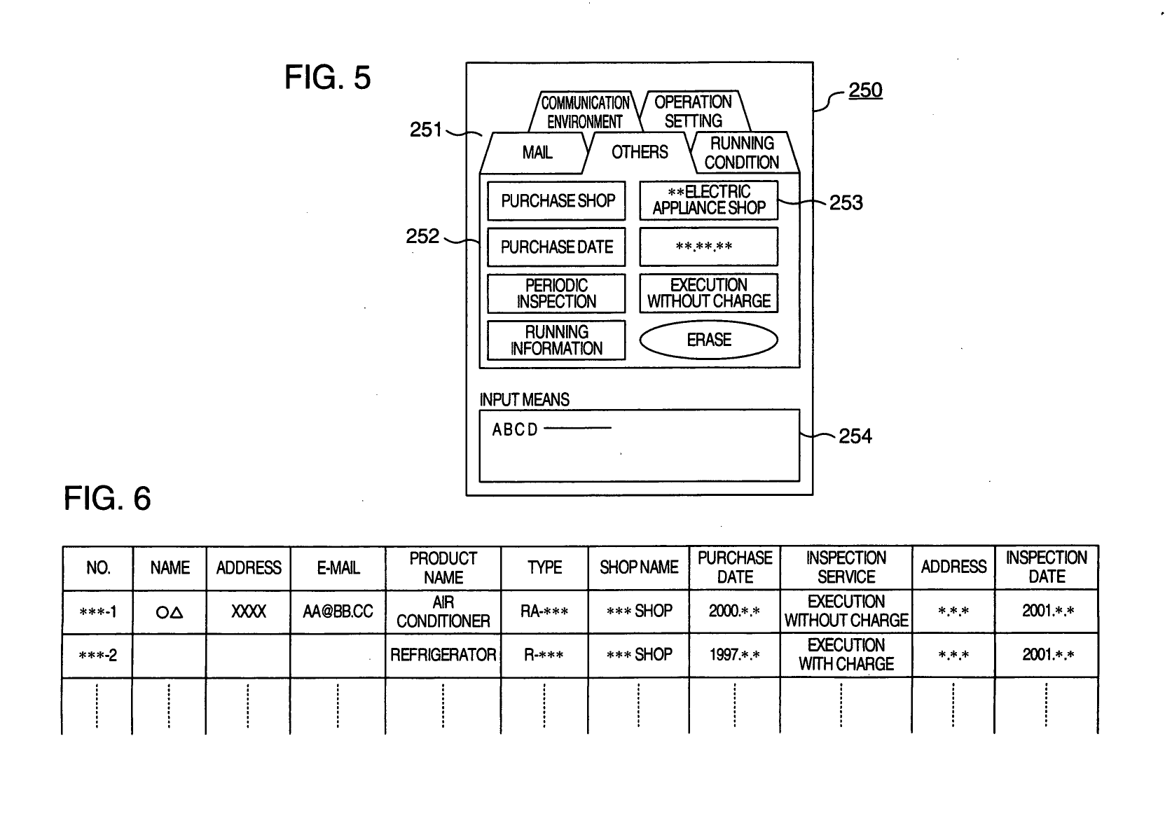

Setting of the refrigerator 201 is done with a liquid crystal panel 250 provided on the refrigerator door 213. This will be described in greater detail with reference to FIGS. 3, 4 and 5. The liquid crystal panel 250 includes a tab 251 for setting item selection, a setting item display 252, an input display 253 and input means 254. When an operation setting is selected with the tab 251, refrigerate compartment, vegetable compartment and freezer compartment temperatures are indicated on the setting item display 252 and the respective temperatures can be inputted to the input display 253 by means of the input means 254. When communication environment is selected with the tab 251, remote control, periodic inspection and fault notification are indicated on the setting item display 252 and for remote control and periodic inspection, ON/OFF and password are inputted to the input display 253 to ensure fault notification in the event of the occurrence of a fault. An item “others” of tab 251 is provided with a data erase switch for erasing, during disposal, the running information stored in the information recording unit 234. At that time, the product information is not erased so that even when the owner is changed through transfer or the like, periodic inspection can be carried out so long as a contract for periodic inspection is newly made.

Connected to the server 300 inside the service center 3 are a workstation 301 for fault analysis, customer data 302 recording customer information, product data 303 recording information of the individual household electric appliances and a printer 304 for delivery of the result of analysis. The server 300 is provided with a communication line, though not shown, to ensure information exchange with the production maker and shop.

As shown in FIG. 6, the customer data 302 is registered with name, address and E-mail address of customers, name, type and shop of products, execution/non-execution of periodic inspection service, inspection date and fault history. A contract for periodic inspection can be made upon purchase in such a manner that service is given without charge within a guarantee period of the product, for example, and thereafter the user can select at discretion a renewed contract for chargeable service. Consumer data 302 of the contractor receiving chargeable service is added with contract period and account number and an amount of money settled at the contract is drawn out of the account each time that an inspection is carried out.

When a user buys a network connectable household electric appliance constructed as above, the user makes a contract for periodic inspection through a shop, mailing or a homepage or Web site of the Internet, for instance. Since the guarantee period proceeds for one year following the purchase, the user can receive a maintenance and inspection service without charge during this period. Then, with the contract made, the user is registered in the customer data and periodic inspection is done every constant period (for example, every week). When the result of periodic inspection shows that any abnormal spot is not particularly found, a notification purporting that no abnormality is found as a result of inspection is sent to a personal computer of the user by electric mail or to, for example, a liquid crystal display unit if the household electric appliance is provide with the display unit. This notification may take the form of a postal card to be sent by mail. In this case, the server of the service center automatically prints out the postal card. In this manner, the user can know that the periodic inspection is done and can confirm fulfillment of the contract.

Then, in the event that a fault or abnormality is detected, the server indicates it on a display unit inside the center and in some cases, prints it out. If the user is ready to use electronic mail, a message of fault or abnormality detection is notified to a personal computer of the user by electronic mail or if the household electric appliance is provided with, for example, a liquid crystal display unit, the message is notified to the display unit by electronic mail. In case the environment is not suited to the use of electronic mail or the user rejects electronic mail, a service engineer informs the user of the fault or abnormality detection by telephone. Then, the contents of the fault and a schedule of repair as well are consulted. Subsequently, the service engineer visits a user's house to work in repair. It should be understood that an abnormality is a sign of a fault and by detecting the abnormality, the household electric appliance can be repaired before it becomes faulty and inoperative. When taking the refrigerator, for instance, the refrigerator can advantageously recover normality before foodstuffs become rotten or frozen foodstuffs defrost completely.

The results of the maintenance and inspection can be read even at a subject shop by accessing the server; and otherwise are automatically transmitted from the server to the shop while targeting a terminal unit such as personal computer of the shop. In this manner, the shop can use the data to talk to the customer in various ways about an explanation of causes of the fault or about how to use the household electric appliance, thus improving intimacy with local customers.

A notification to the effect that the maintenance service period expires before one year passes from the purchase of the household electric appliance by the user is sent to the user by electronic mail or postal card prepared by the server similarly to the above. Since the guarantee period has expired, a chargeable service is given from now on. If the guarantee period of defective parts is still alive, costs of repairing the parts are not charged. When the user wants the maintenance contract to continue, a message to this effect is returned to the service center by electronic mail or by reply postal card. The service center receiving the return message works to set an item of inspection service in the customer data to “presence” and set an item of charge/no charge to “chargeable”. Then, a maintenance service similar to the above is carried out. Contrarily, when the user notifies undesirability for the maintenance service, work to make the item of inspection service “null” is done without erasing the consumer data. The reason why the consumer data is not erased is that the user is allowed to be ready for desiring resumption of the service later (especially, when years have elapsed following the purchase of the household electric appliance, there is a high possibility that faults occur and in this case, a desirability for receiving a periodic inspection service will arise). Otherwise, a notification may be issued to inquire whether a maintenance contract is made at intervals of one year.

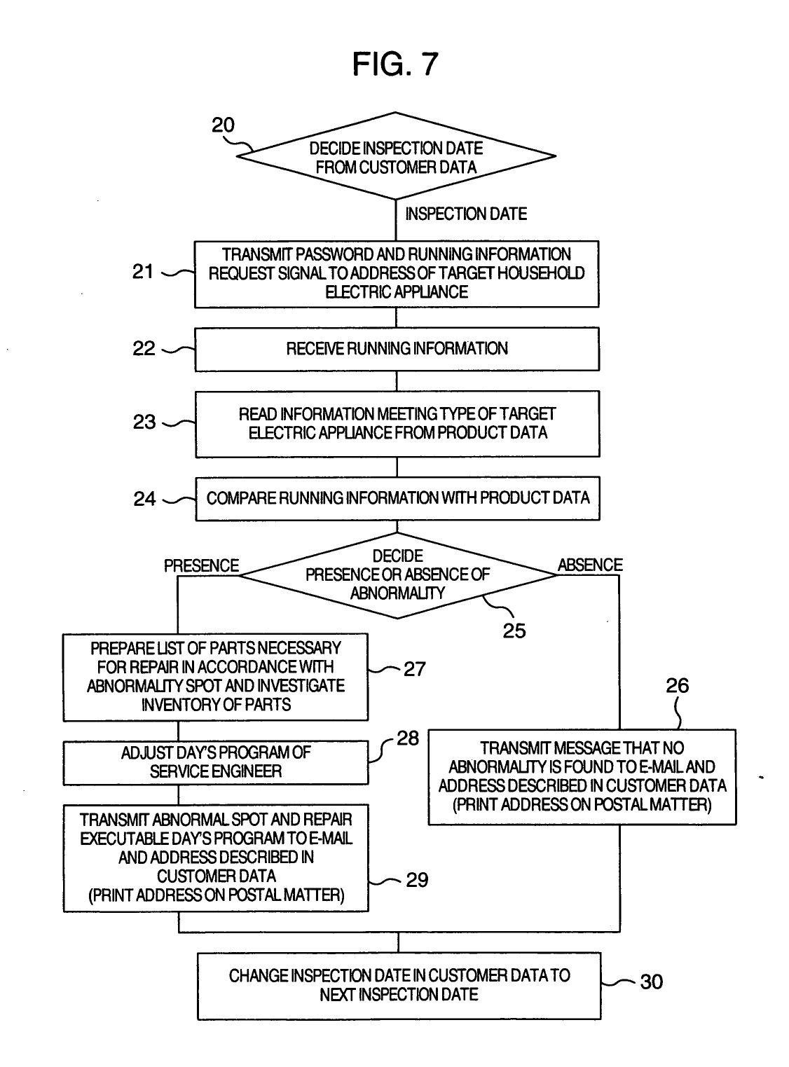

With reference to a flowchart illustrated in FIG. 7, a description will be given by taking the refrigerator 301, for instance. In case the date is so determined as to fall on an inspection day described in the consumer data 302 in step 20, the workstation 301 in the service center proceeds to step 21 to transmit a password and a running information request signal to the refrigerator 301 through the server 300, public line and domestic server 200. If, at that time, the periodic inspection in the liquid crystal panel 250 is ON (even during the maintenance and inspection service period, the user does not sometimes want data to be transmitted and in such a case, by rendering the periodic inspection switch off, even the running information request signal transmitted from the server of service center can be neglected), data recorded on the information recording unit 234 is returned only when a set password coincides with the transmitted password. In step 23, the workstation 301 receiving the returned data in step 22 reads product data stored in the product data 303 on the basis of the transmitted product information and in step 24, inspects the presence or absence of an abnormality of the household electric appliance.

More particularly, the workstation first reads temperatures in the refrigerate compartment, vegetable compartment and freezer compartment which are set on the liquid crystal panel 250 through running setting and temperatures detected by the refrigerate compartment temperature detector 241, vegetable compartment temperature detector 243 and freezer compartment temperature detector 244 when door open or close is not detected with the door open/close detector 247 for a constant period and compares read values with reference values stored in the product data 303 so as to determine that the basic function of the refrigerator is normal if differences are below allowable values but determine an abnormality when the differences are above the allowable values. Next, the functions of individual parts are inspected. Revolution numbers of the compressor 221, refrigerate compartment cooling fan 225, freezer compartment cooling fan 242 and condenser fan 223 are compared with set value. This set value is reference values in the product data, and the reference values are parameter of temperature detected by the refrigerate compartment temperature detector 241, vegetable compartment temperature detector 243 and freezer compartment temperature detector 244. If differences are below allowable values, these parts are determined to be normal but if the differences are in excess of the allowable values, they are determined to be defective. Further, by using the revolution numbers of the compressor 221, refrigerate compartment fan 225, freezer compartment fan 242 and condenser fan 223 and the temperatures detected with the air temperature detector 240, refrigerate compartment temperature detector 241, refrigerate compartment cooler temperature detector 242, vegetable compartment temperature detector 243 and freezer compartment temperature detector 244, reference temperatures of the compressor, condenser, refrigerate compartment cooler and freezer compartment cooler are calculated from the appliance data and the calculated temperatures are compared with temperatures detected with the refrigerate compartment cooler temperature detector 242, freezer compartment cooler temperature detector 245, condenser temperature detector 246 and compressor temperature detector 247. If differences are below allowable values, normality is determined but if the differences exceed the reference values, abnormal spots are presumed from parts in which temperatures in excess of the reference values are generated and from a database recorded on the appliance data 303. For example, when temperatures detected with the refrigerate compartment cooler temperature detector 242, freezer compartment cooler temperature detector 245 and condenser temperature detector 246 are lower than the reference values and a temperature detected with the compressor temperature detector 247 is higher than the reference value, leakage of refrigerant is determined.

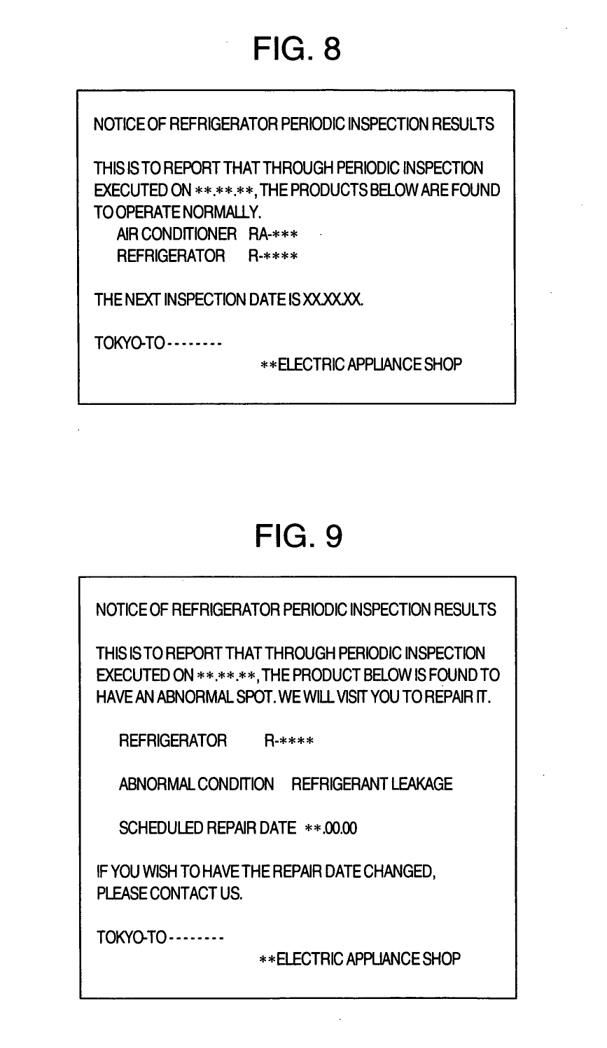

In step 25, the presence or absence of an abnormality is decided and if no abnormality is determined, the program proceeds to step 26 in which a message that normal operation is proceeding is given to the user. At that time, in addition to the electronic mail described in the customer data, a described address and the result of inspection shown in FIG. 8 are printed to a postal matter by using the printer 304. Transmission to the electronic mail address can permit the user to know the inspection result by using the cell phone or a different display unit, thus ensuring that the individual household electric appliances need not be provided with the display function. Through the additional use of the postal matter, availability by a person not using the Internet or the like can be assured or an oversight of mail can be prevented. In case the household electric appliance is provided with the function of displaying electronic mail, the result can also be transmitted to the household electric appliance. By designating the shop name acquainted with the user as an addresser, it is possible to give the user safety feeling and reliability feeling (as described in the precedence, the shop is conditioned to see the result of inspection of the household electric appliance).

If an abnormality is determined in the step 25, the server 300 indicates a message to this effect on the display unit inside the service center 3 or in some cases, causes the printer 304 to print out the message. Gathering from the abnormal spot determined in the step 24, the server 300 prepares a list of tools necessary for repair and besides detects an inventory condition of service parts from the database in step 27, calculates a day's program applicable to repair or determines an available date for repair in accordance with a schedule of the service engineer in step 28 and describes or writes the abnormal spot and the day's program applicable to repair or the available date for repair as shown in FIG. 9 so as to inform the user of them in step 29. The service engineer per se can also make this notification. In such a case, the server 300 can display or print out at least the abnormal spot and the inventory condition of the service parts.

In the event of the occurrence of an abnormality, in addition to the electronic mail and postal matter, a notification to the shop may be made to let it visit the user's house in order to inform the result and adjust the repair date. In step 30, the inspection date in the customer data 302 is changed to the next inspection date, thus ending the periodic inspection.

Even if no abnormality or fault is found through the periodic inspection, the household electric appliance will sometimes become defective because of an accident such as for example a thunderbolt or intrusion of water into the electronic appliance. In such an event, generally, the user informs the shop or service center of the accident by phone but defective conditions can hardly be explained and the service engineer of the service center will have difficulties in specifying a faulty spot or an abnormal spot. To eliminate such inconvenience, when determining that the household electric appliance becomes abnormal or defective, the user selects the communication environment by means of the tab 251 on the liquid crystal panel 250 and turns on the notification switch for fault information.

With the notification switch for fault information depressed, a password for periodic inspection and running information are sent to the workstation 301 through the domestic server 200, public line and server 300. When, in the workstation 301, an address of the household electric appliance described in the customer data 302 coincides with the password, the appliance data 303 is compared with the transmitted running information as in the case of the periodic inspection and abnormal spots, necessary tools and service parts are listed up as in the case of the periodic inspection, and the defective spots and a repair executable day's program meeting a day's program of the service engineer are informed to the user.

As described above, in the present embodiment, by providing storage means for recording running information necessary for control of the appliance and a predetermined password and means for transmitting the running information in response to a running information request signal and a password signal from the outside when coincidence of password is settled, the running condition can be grasped from the external appliance safely without resort to special analyzing means provided to the household electric appliance. When the user sets a password for periodic inspection different from the password used for the user to change setting and monitor the running condition from, for example, the cell phone, unnecessary personal information will not be transferred or seen from outside, thus ensuring safe use.

Incidentally, as a defective form of the household electric appliance, a fault of the power source unit is conceivable. In the case of such a failure, power is not supplied to a board of communication components and as a result, a maintenance and inspection service cannot be received in spite of the occurrence of the fault. To cope with this problem, a backup power source serving as a power source system different from that of the household electric appliance is provided in the power source unit of the transmitting and receiving means of the remote control network. The backup power source is a chargeable and dischargeable secondary battery which is charged by being fed with charging current from a DC line of the power source unit of the household electric appliance proper. With this backup power source, even when the power source of the household electric appliance proper becomes abnormal owing to the occurrence of an abnormality and operation of the appliance proper is stopped, the communication unit can still operate to transmit a running condition at the time that the abnormality occurs to the service center or the like, so that a faulty spot can be grasped to permit quick repair. As appliances fed by the secondary battery, the memory recording the running information may be enumerated in addition to the communication appliance.

Further, by providing communication means capable of exchanging information with a remotely-located household electric appliance and means for transmitting a predetermined signal and a signal for requesting running information to the household electric appliance at intervals of a predetermined period and comparing the running information returned from the household electric appliance with appliance data of the household electric appliance so as to analyze whether the running condition is normal or abnormal, the presence or absence of an abnormality can be grasped with high accuracy and in case the abnormality is trifling, repair can be done before the household electric appliance is stopped. The database of appliance data is easily modifiable and decision of abnormality can always be made with the latest data. Furthermore, by providing means for comparing running information returned from the household electric appliance with appliance data of the household electric appliance and informing the result of comparison and in the presence of an abnormality, abnormal spot and inspection date to the user of the household electric appliance, the user can be allowed to know a running condition of the household electric appliance and to use the household electric appliance at ease. By automating a series of flow by means of the workstation, costs can be reduced and even in the case of a charged fulfillment, service can be offered inexpensively. In addition to the communication means such as electronic mail, postal service can be employed as notification means to permit even a user not using Internet at all to receive service.

Further, a fault notification required in the event that the communication controller is out of order is made on the basis of information from the user as in the case of the prior art but the original function of the household electric appliance can still be used and therefore the appliance is less affected even if repair is not carried out quickly.

In the foregoing embodiment, the refrigerator is used as the network connectable household electric appliance but even the air conditioner, electronic range and like can be operated comparably so long as they have the digital control unit.

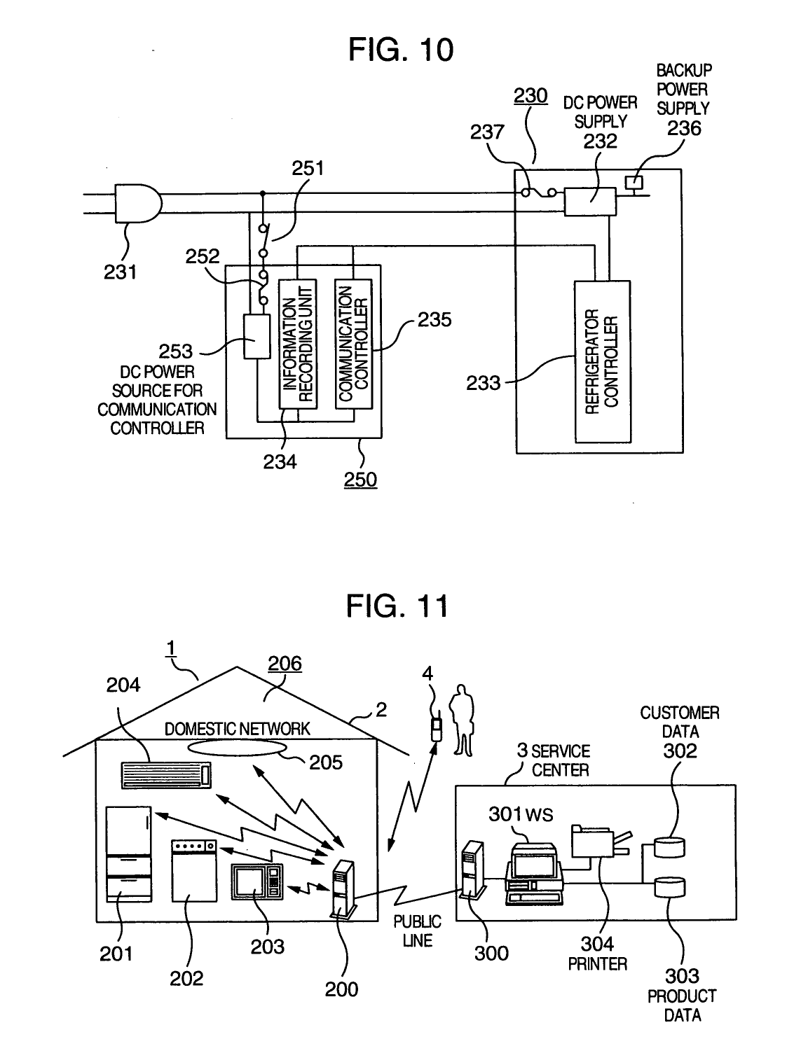

Referring to FIG. 10, another embodiment of the power source system of the network connectable household electric appliance in the above embodiment. In FIG. 10, reference numeral 250 designates a communication controller substrate and AC power supply from a plug socket 231 branches on the way and is fed to a communication controller switch 251, a communication controller fuse 252 and a communication controller DC power source 253. DC power supply obtained from the communication controller DC power source 253 is fed to an information recording unit 234 and a communication controller 235. Other components are the same as those in FIG. 2. Even in the event that the household electric appliance control power source substrate 230 becomes faulty, electric power can be supplied to the information recording unit 234 and consequently, running information stored till then can be transmitted to the service center without fail.

With the above construction, the same meritorious effects as those in the foregoing embodiment can be attained and besides, power supply to the communication control substrate can be prevented by turning off the switch 251 to meet the user not requiring the network function, thus preventing unnecessary power consumption such as queued power.

Another embodiment of the present invention is illustrated in FIG. 11. Network connectable household electric appliances 206 such as refrigerator 201, washing machine 202, microwave oven 203, air conditioner 204 and lighting fixture 205 can communicate with a domestic server 200 by way of an electric wave. Other components are the same as those in the foregoing embodiments.

With the above construction, there is no need of laying a communication cable inside a house and the communication environment can be set up easily. In addition, the installation location of the household electric appliance can be changed easily and similar service can also be offered to a cordless household electric appliance.

According to the embodiments set forth so far, the network connectable household electric appliance comprises storage means for recording running information and a predetermined password and means, responsive to a running information request signal and a password signal from outside, to transmit the running information when coincidence of password is settled, whereby a running state can be grasped safely from an external appliance without resort to special diagnostic means provided to the household electric appliance. In addition, by providing the power source unit of the transmitting and receiving means of the network with a power source system different from that of the household electric appliance proper, the communication unit can operate even in the event that the power source of the household electric appliance proper becomes abnormal owing to the occurrence of an abnormality and hence a running state during the occurrence of the abnormality can be transmitted to the service center and the like to ensure that a defective spot can be grasped and repair can be made quickly.

Further, by providing communication means capable of exchanging information with a household electric appliance at a remote location and means for transmitting a password and a signal requesting running information to the household electric appliance at intervals of a predetermined period and comparing the running information returned from the household electric appliance with appliance data of the household electric appliance so as to analyze whether the running state is normal or abnormal, the presence or absence of an abnormality can be grasped with high accuracy. In case the abnormality is slight, repair can be made before the household electric appliance stops. Also, by providing means for comparing the running information returned from the household electric appliance with the appliance data of the household electric appliance and when an abnormality is found as a result of the comparison, informing the user of the household electric appliance of an abnormal spot and an inspection date, the user can know the running state of the household electric appliance and can use the household electric appliance at ease.

According to the present invention, a household electric appliance inspecting system can be provided which can inspect a household electric appliance at low costs without providing the household electric appliance with special diagnostic means and which does not give uneasy feeling to the user or possessor of the appliance.

Further, according to the invention, a household electric appliance can be provided which can be serviced for repair of an unexpected fault of the household electric appliance.

In addition, according to the invention, a service can be provided which can ensure inspection of a household electric appliance at low costs without resort to special diagnostic means provided to the household electric appliance and does not give uneasy feeling to the user or possessor of the household electric appliance.

It should be further understood by those skilled in the art that although the foregoing description has been made on embodiments of the invention, the invention is not limited thereto and various changes and modifications may be made without departing from the spirit of the invention and the scope of the appended claims.

1. A household electric appliance inspecting system comprising:
a function of storing running information of a household electric appliance connected through a network;
a function of deciding from the stored running information whether said household electric appliance operates normally; and
a function of converting, when no abnormality or fault is detected, a message indicative of no detection of abnormality or fault into electronic mail and transmitting the electronic mail to a display unit provided in said household electric appliance or a terminal unit possessed by a user of said household electric appliance.

2. A household electric appliance inspecting system comprising:
a function of storing running information of a household electric appliance connected through a network;
a function of deciding from the stored running information whether said household electric appliance operates normally; and
a function of preparing, when no abnormality or fault is detected, a postal card describing a message indicative of no detection of abnormality or fault.

3. A household electric appliance inspecting system having a unit for deciding, on the basis of running information of a household electric appliance connected through a network, the presence or absence of a fault or abnormality of said household electric appliance, said system comprising:
a function of converting into electronic mail an inquiry made to a user of said household electric appliance and inquiring whether a service of the inspecting system is to be continued, before a constant period following purchase of said household electric appliance expires, and transmitting the electronic mail to a display unit provided in said household electric appliance or a terminal unit possessed by the user.

4. A household electric appliance inspecting system having a unit for deciding, on the basis of running information of a household electric appliance connected through a network, the presence or absence of a fault or abnormality of said household electric appliance, said system comprising:
a function of preparing a postal card describing an inquiry made to a user of said household electric appliance and inquiring whether a service of the inspecting system is to be continued, before a constant period following purchase of said household electric appliance expires.

5. A household electric appliance having a transmitting and receiving unit connected to a network to make communication with the outside, said appliance comprising:
a power source unit provided for said household electric appliance and a power source unit provided for said transmitting and receiving unit.

6. A household electric appliance according to claim 5, wherein the power source unit for said transmitting and receiving unit is a chargeable and dischargeable battery which is chargeable with electric power fed from the power source unit for said household electric appliance.

7. A household electric appliance connected through a network to a service center for diagnosing a fault or abnormality of said household electric appliance on the basis of transmitted running information, said appliance comprising:
a notification switch for informing said center of a fault; and
a function of transmitting running information of its own when said notification switch is turned on.

8. A household electric appliance inspecting service which uses a unit for deciding, on the basis of running information from a household electric appliance connected through a network, the presence or absence of a fault or abnormality of said household electric appliance and dispatches a service engineer in the case of the occurrence of a fault or abnormality, wherein a service based on said decision unit is given without charge during a constant period following purchase of said household electric appliance and after the constant period, a service based on said decision unit is given with charge when a request is made from a user of said household electric appliance.

9. A household electric appliance inspecting service which uses a unit for deciding, on the basis of running information from a household electric appliance connected through a network, the presence or absence of a fault or abnormality of said household electric appliance and dispatches a service engineer in the case of the occurrence of a fault or abnormality, wherein a service based on said decision unit is given without charge during a constant period following purchase of said household electric appliance, and before expiration of said constant period, an inquiry is made to a user of said household electric appliance to inquire whether the user wants the service to be continued and after the constant period, a service based on said decision unit is given with charge when a request is made by the user of said household electric appliance.
